(19) United States
(12) Patent Application Publication
(10) Pub. No.: US 2003/0031859 A1
(43) Pub. Date: Feb. 13, 2003

(54) Processing and apparatus for production of engineered composite combining continuous-strip sheet metal and thermoplastic polymers

(76) Inventors: John A. Sinsel, Weirton, WV (US); Mark V. Loen, Steubenville, OH (US); Michael S. Bailey, Landenberg, PA (US)

Correspondence Address: Raymond N. Baker, SHANLEY AND BAKER, 2233 Wisconsin Avenue, Washington, DC, 20007, US

(21) Appl. No.: 10/191,411

(22) Filed: Jul. 9, 2002

Related U.S. Application Data
(63) Continuation-in-part of application No. 10/156,473, filed on May 28, 2002.
Application No. 10/156,473 is a continuation-in-part of application No. 09/767,785, filed on Jan. 23, 2001, now abandoned.
Application No. 09/767,785 is a continuation-in-part of application No. 09/490,305, filed on Jan. 24, 2000, now abandoned.

(51) Int. Cl. B32B 15/08; B32B 1/00

(52) U.S. Cl. 428/332; 428/461; 428/458; 156/244.23; 156/244.24

(57) ABSTRACT

Processes and apparatus for manufacturing an engineered-composite combining rigid flat-rolled sheet metal continuous-strip and selected polyester thermoplastics, which are formed into distinct polymeric layers for melted extrusion deposition on a single surface, at a time, using pressure dies, and other steps, for forming a uniform coat of distinct polymeric layers, which provide high green-strength-adhesion during continuous-in-line travel; and including dual-surface finishing for complete bonding of the polymeric layers on both metallic surfaces.

### RELATED APPLICATIONS

This application is a continuation-in-part of U.S. application Ser. No. 10/156,473 filed May 28, 2002, which is a continuation-in-part of U.S. application Ser. No. 09/767,785 filed Jan. 23, 2001, which is a continuation-in-part of U.S. application Ser. No. 09/490,305 filed Jan. 24, 2000, entitled “Polymeric Coated Metal Strip and Method for Processing Same.”

### INTRODUCTION

This invention relates to methods and apparatus for combining extrusion polymeric coating with rigid flat-rolled sheet metal producing engineered composites which contribute advantageous end-usage product; and, more specifically, is concerned with process and apparatus for surface preparation and polymeric coating of rigid sheet metal, a single-surface at a time, during continuous-in-line travel of such sheet metal continuous-strip.

### OBJECTS OF THE INVENTION

Important objects are providing preparation for, and achieving, extrusion deposition of a combination of versatile and durable polyester thermoplastics, which co-act with pre-selected surfaces of rigid flat-rolled sheet metal continuous-strip by adding performance capabilities for fabricated usage.

### BRIEF DESCRIPTION OF THE DRAWINGS

FIG. 1 is a flow-chart box-diagram presentation for describing production processing of the invention;

FIG. 2 is a schematic view, partially in cross-section, of a continuous-strip apparatus embodiment of the invention, for describing in-line operations of the invention; and

FIGS. 3 through 6 are enlarged cross-sectional views for describing representative coil-coated embodiments of the invention.

### DETAILED DESCRIPTION

Advantages of extrusion deposition of designated thin-film thermoplastic polyesters of the invention, have been overlooked for the selected continuous-strip flat-rolled rigid sheet metals; or, possibly, have been avoided because of difficulties which obstructed successful polymeric-toll-coating operations with the selected polyesters of the invention. Recognizing and analyzing those problems along with the solutions discovered, are part of the present invention.

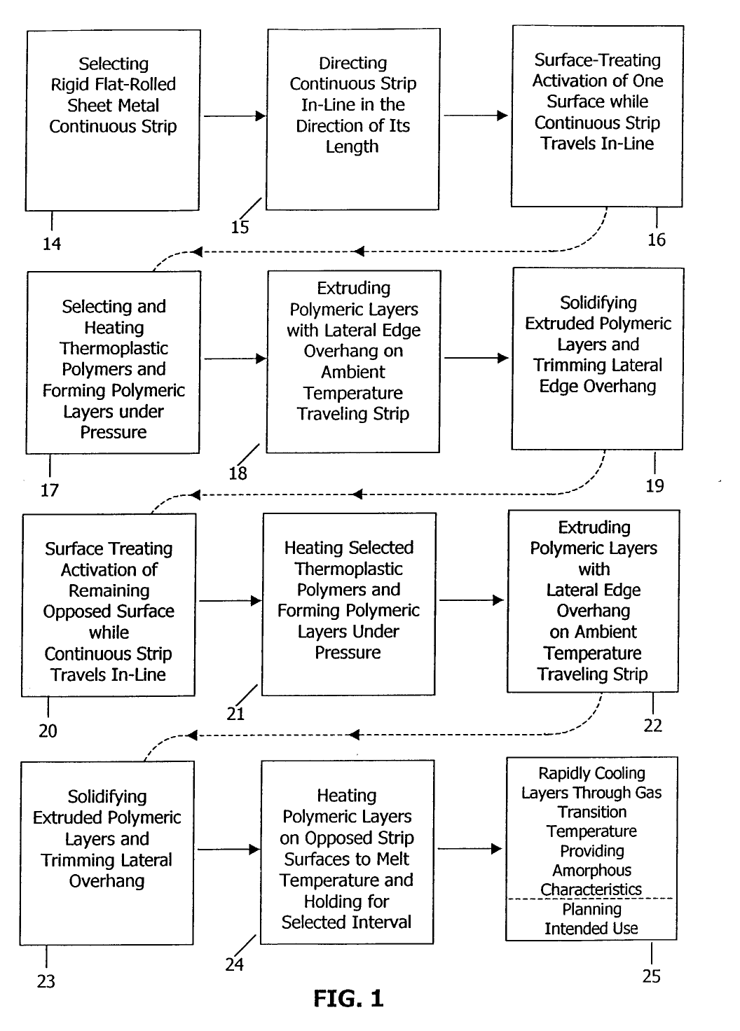

Rigid flat-rolled sheet metal is selected, in continuous-strip form, for initiating continuous-in-line processing at Station 14 of FIG. 1. Flat-rolled sheet metals are selected at gages which provide rigid sheet metal continuous-strip. Thickness gages above 0.002″ are selected for low-carbon steel; above about 0.0045″ for aluminum and for selected flat-rolled aluminum/magnesium alloys. Such rigid flat-rolled sheet metal selections facilitate in-line handling and contribute to directing elongated work product as continuous-strip in the direction of its length, which is initiated at Station 15 of FIG. 1.

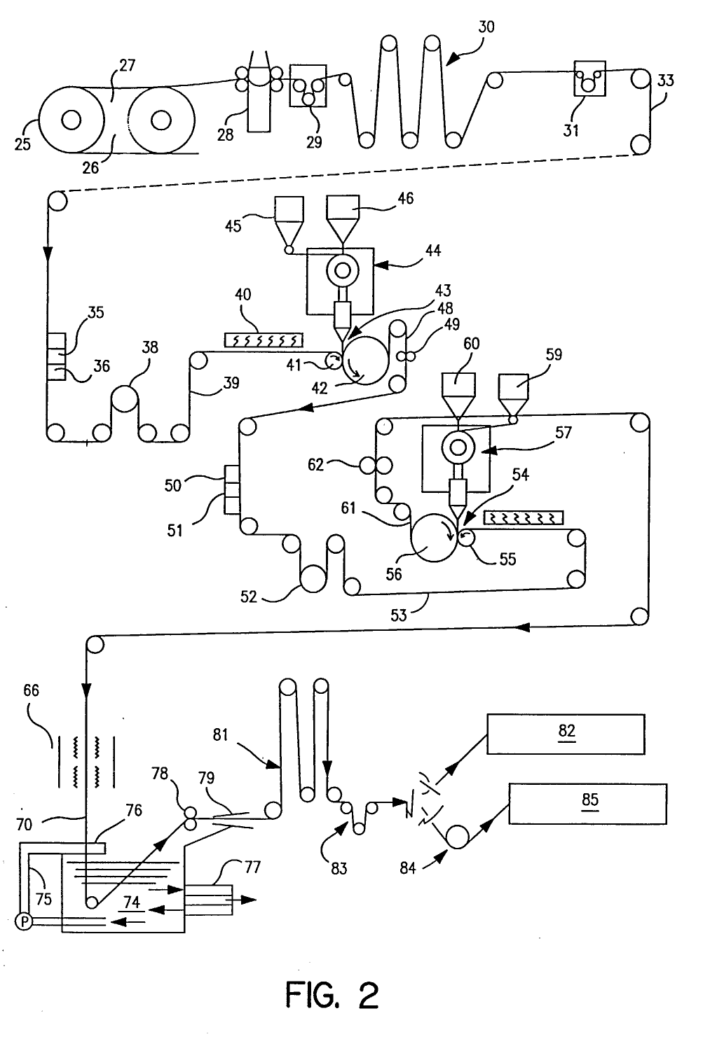

Such selected rigid flat-rolled sheet metal strip is directed to present substantially-planar opposed surfaces extending between elongated longitudinally extended lateral edges. And, as better seen in relation to FIG. 2, continuous in-line travel extends from uncoiling that continuous-strip, to completion of uniform polymeric coating for each such surface, a single surface at a time, to finishing of both such surfaces, and to selective recoiling.

Referring to Station 16 of FIG. 1, in accordance with the invention, a single-opposed surface, of the selected rigid sheet metal strip, is prepared for and polymeric coated at a time. Preparation of such a single-surface for selected polyester extrusion deposition includes open-flame and corona-discharge pre-treatments to remove surface particulate and to energize, or activate, that surface. Further preparation includes establishment of a selected surface temperature, which is less than the melt temperature for the selected polyester first-contacting layer, but which facilitates uniform coating. The objective, of those preparation steps, is achieving a polymeric coating which is unitary and coherent, across the coated surface area; and, which provides sufficient green-strength-adhesion to enable continued travel of the strip, as polymeric coated on a single surface at a time, in-line. An open-flame surface-contact treatment is provided with air/fuel ratio control so as to produce an oxidizing reaction by impingement on that strip surface. A corona-discharge plasma can also contribute to desired bonding between an activated inorganic metallic surface and a first-contacting organic polymeric layer. Such pre-treatment and surface preparation steps, equipment, and results are described in more detail in relation to FIG. 2.

Thermoplastic polymers are selected and formed into polymeric layers at Station 17 of FIG. 1; melting is carried-out by combining heating and pressurizing in extrusion apparatus for deposition of distinct polymeric layers. The dual polymeric layers consist essentially of

(i) Polyethylene Terephthalate (PET) as a first-contacting layer with the metallic-surface, and

(ii) a finish-layer selected from the group consisting of

(a) Polybutylene Terephthalate (PBT)

(b) PET, and

(c) a combination of (a) and (b),

That finish-surface layer adheres to the first-contacting layer.

At Station 18 of FIG. 1, the melted polymeric layer selected for first contact (PET) is extruded onto a pre-treated and temperature-controlled single surface. A distinct finish-surface polymeric layer, such as PBT, is simultaneously extruded for associated deposit on that first-contact layer. Extrusion each thin-film, of selected thickness is carried out by elongated dies extending between lateral edges of that single surface. Such dies also extend further, so as to provide a polymeric overhang at each lateral edge of the strip.

PET and PBT polyesters have been selected for their strength and stability; and, among other desirable properties for low moisture absorbency and abrasion-resistence surface properties. Flat-rolled rigid sheet metals are selected for the capability of maintaining tensile strength and impact-resistence throughout a wide-range of temperatures; and, combining those properties with those of the selected polyesters, in accordance with the invention, contributes a coaction producing capabilities greater than mere additive mechanical properties.

The selected first-contacting PET polymeric layer is deposited so as to achieve high green-strength-adhesion, and to maintain that adhesion on such single-surface for continuous in-line travel of the strip in the direction of its length. However, difficulties with deposition of such high-melt temperature polyester, as a unitary and coherent first-contacting layer, were analyzed and solved, as described later herein.

PBT is preferred as the finish-surface polymeric layer; or, at least as a part of, that finish-surface layer. PBT, in addition to its surface toughness, contributes lubricity for fabrication purposes. Also, PBT was chosen for its adhesion as a finish-surface layer which extruded as a distinct layer readily combines with the first-contacting PET polymeric layer.

PET has a melt temperature of about 475° F. Extrusion deposition of a thin film of PET, at melt temperature, was found to be disruptive; and, counter to an objective of achieving unitary continuity, and uniformity, across the strip surface. However, it was discovered that, by establishing a single surface-temperature above about 200° F., those difficulties could be overcome. An in-line-established single surface temperature is preferably selected in the range of about 230° F. to about 245° F. considering the full range of metallic surfaces of the invention. Overcoming those prior obstacles to obtaining a unitary green-strength-adhesion has been achieved while maintaining continuous-in-line travel operations.

Therefore, heat removal, at Station 19, FIG. 1, in order to solidify the melted polyester extrusion layers in-line is carried out at an increased heat-removal rate from the polymeric layers, as well as the strip, while the strip is traveling at the continuous-in-line production rate. In-line heat-removal from the high-melt temperature polymeric coatings, and the strip, is carried-out by presenting, and maintaining, in-line heat-removal surface-contact with the extrusion coated polymers at a selected and controlled temperature. The heat-removal surface is maintained at such selected temperature, for example in the range of about 55° F. to about 75° F., so to provide desired solidification of the polymeric layers during in-line travel. Heat is also removed from the polymeric overhang so as to provide for in-line trimming of solidified polymeric overhang, along each lateral edge; preferably at a location in-line shortly after desired solidification is established.

Polymeric overhang is purposefully established in accordance with the invention. It was found that polymeric extrusion, utilizing elongated dies so as to extend a thin-film across strip width, resulted in an “edge-build-up” occurring, at each lateral edge of the die as the polymeric layer is being extruded. In order to achieve uniform thickness across strip width, polymeric deposition was extended so as to establish a polymeric overhang at each lateral edge the strip; and, after desired solidification in-line, trimming off that polymeric overhang (with edge-build-up); such single-surface trimming is indicted at Station 19 of FIG. 1.

Strip travel, at a selected continuous-in-line rate in feet-per-minute rate, continues in approaching Station 20, for preparation of the single remaining-opposed surface. Surface pre-treatment steps, and delivering that surface with an established surface-temperature, as described above, provide for enhanced adhesion and deposition, free of disruption of the first-contacting PET layer on that remaining surface.

Selected thermoplastic polyester polymeric layers, as described above, are selected at Station 21 of FIG. 1; that is: a first-contacting PET polymeric layer, and a finish-surface polymeric layer selected from the group consisting of PBT and a combination of PET and PBT. Those polymeric layers are heated and delivered under pressure as set forth above. Extrusion apparatus, described later here in relation to FIG. 2, provides for simultaneous extrusion as distinct polymeric layers.

The first-contacting and finish-surface polymeric layers are extruded, at Station 22, as distinct associated layers, extending across strip width; and, also, extending further so as to establish a polymeric overhang at each lateral edge.

Solidification of the polymeric layers associated with the single remaining surface, enables heat removal from the polymeric layer and the strip, while the strip is traveling at line speed. Deposited polymeric layers are melted at a temperature above about 475° F., and, a surface-temperature for the remaining-surface is established above about 200° F.; preferably in a range of about 230° F. to about 245° F. The rate of heat removal is established for a selected line speed. Heat-removal means, for a line speed of about six to about eight hundred feet per minute (about 600 to about 800 fpm), utilizes in-line surface-contact, with the coated polymers, which is controlled at a temperature in the range of about 50° F. to about 75° F. Solidification of such polymeric coating and the polymeric overhang, along with trimming solidified lateral-edge overhang after solidification, are carried out at Station 23 of FIG. 1.

Travel in-line, is continued toward a finishing stage for completing bonding of polymeric layers, associated on respective opposed surfaces. Referring to Station 24 of FIG. 1, polymeric layers on both surfaces are heated to melt temperature while the polymeric coated strip is traveling in-line. The temperature of the polymeric layers, can extend to temperature about 100° F. above such melt-temperature, for some metallic surfaces; and induction heating of the strip can be used to facilitate in-line heating and, travel in-line is selected for a brief time interval.

That combination, heating to a selected temperature and a selected travel time in-line, provides for completing bonding of the polymeric layers. The polymeric layers, in particular the first-contacting layer fills valleys and crevices, which may exist due to the topography of each metallic surface; and, the finish-surface polymeric layer bonds with the first-contacting polymeric layer on each respective surface, so as to present a smooth-exterior dual-layer polymeric coating on each surface.

The surface pre-treatment and preparation steps, described above, establishes a bonding adhesion of the first-contacting PET layer with each respective metallic surface. The bonding between each activated inorganic metallic surface of the strip, and the first-contact inorganic polymeric PET layer appears to be a type of chemical bonding.

After such finishing heating, and selected in-line travel, at Station 24, the polymeric layers associated with each surface are rapidly cooled through glass transition-temperature for those polymers, at Station 25 of FIG. 1. It has been found that, such rapid cooling, of the selected polyester polymeric layers of the invention, is effectively achieved by using a quench bath, containing a selected heat-removal liquid; with flow control and control, as necessary, of the temperature of the heat-removal liquid, so as to enable a rapid decrease in temperature of the polymeric layers to glass-transition temperature (approaching about 50° F.); heat is also removed from the strip.

Rapid cooling of the polymeric layers, through respective glass-transition-temperatures, helps to establish the desired non-directional amorphous characteristics, in the polymeric layers, which facilitate subsequent fabrication of the composite into end-usage products.

The polymeric coated strip is than directed for optional recoiling, or for an initiating step for end usage; an example of the latter includes a type of corona discharge treatment of polymeric coated surface, at a level selected to facilitate lithographic printing, or painting, of that surface; where planned for end usage preparation.

Continuous-in-line apparatus for carrying out the above described production process is shown schematically in FIG. 2. Preferably, as taught herein, prior to in-line polymeric cooling production processing, metallic surfaces of the sheet metal substrate are pre-cleansed; and, flat-rolled mild steel surfaces are also preferably protected with a non-ferrous metallic coating prior to entry into the in-line polymeric coating production processing of invention.

Separating such sheet-metal manufacturing steps, from the polymeric coating production processing line, facilitates desired control of the single-surface, at a time, polymeric coating; and, facilitates handling of the strip for single-surface, at a time, preparation and polymeric coating at selected line speed. The present technology combines the advantages of single-surface preparation and coating with a sustained high production rate, selected in the range of about 600 to about 800 feet per minute, without compromising polymeric-layer/metallic surface adhesion quality on either surface.

Referring to FIG. 2, coils and equipment are arranged at an entry section which enables in-line continuous-strip processing. Continuous strip, from coil ramp 26, is directed to shearing and welding station 28, providing for continuous-strip in-line travel. Bridle rolls at 29, looper 30, and bridle rolls at 31 facilitate maintaining continuous-strip for continuous in-line processing; and, help to establish and maintain desired production rate in-line.

Rigid flat-rolled sheet metal substrate 33 travels in-line for preparation of a single surface, at a time, for polymeric coating. Open-flame burners, such as 35 and 36 burn-off any surface lubricant, and particulate debris, from that flat-rolled sheet metal surface. The oxygen/fuel ratio is controlled, in the open flame burners, so as to produce a flame-contact oxidizing-reaction as impinged on a single surface. That reaction has been found to activate such surface so as to enhance reception and adhesion of the first-contacting polymeric layer of the invention.

Ionizing of the gas above that single surface, using an electrical potential near a level to produce arcing, but free of forming an electrical arc with that surface, has also been forward to activate that surface so as to enhance polymeric adhesion. One, or more, corona discharge units, at treatment apparatus 38, can be utilized.

Such single surface pre-treatment steps can be selected from the group consisting of solely open-flame treatment, solely corona-discharge treatment, and a combination of those two pre-treatments in any sequence; so as to achieve desired surface-activation for adhesion of the polymeric coating of the invention. The number of treatment units utilized can vary with the desired line speed to be maintained.

That single pre-treated surface of continuous strip 39 is pre-heated, while traveling in-line, to a temperature above about 200° F.; and, preferably in the range of about 230° F. to about 245° F., prior to polymeric extrusion coating of that single activated surface-temperature that surface heating is preferably achieved using an infra-red unit 40, so as to limit or avoid heating the metal strip throughout its thickness to that selected temperature. With such surface temperature established, strip 39 travels directly for polymeric coating.

Teflon-coated, neoprene roll 41 provides pressure on the polymeric layers being deposited free of adhesion to the surface. And, roll 41 in combination with heat-removal roll 42, establishes coating nip 43. Extrusion apparatus 44 directs melted polymeric layer, under pressure, into coating nip 43, between rolls 41 and 42; each rotating in the direction shown.

Pre-selected thermoplastic polymers are formulated to specifications; including: a first-contacting polyethylene terephthalate (PET) polymeric layer, and a selected finish-surface polymeric layer, as described earlier. Melted polymeric layers, as formulated to specifications, supplied from sources 45 and 46 respectively, are heated and pressurized in extrusion apparatus 44. Heating is augmented by pressurization in response to feeding augers (not shown) for each polymeric layer within extrusion apparatus 44.

Strip 39, with a single pre-treated surface, and with such established surface-temperature, travels into nip 43. Heat-removal roll 42 is preferably chrome plated for receiving the polymeric coating. Teflon-surface pressure roll 41 helps to compact the polymers as extruded onto the strip which is moving in contact with rotating roll 42. The polymeric coating material is at least at melt temperature; and, can be at a temperature about 50° F. above melt temperature; and the strip surface is heated. The surface of rotating heat-removal roll 42 is temperature controlled from internally of the roll to a temperature for heat-removal from the polymeric coatings and from the strip. As described earlier, cooling internally to a temperature in the range of about 50° F. to about 75° F., solidifies the polymeric coating while traveling in-line on heat-removal roll 42; the radius of which is controlled to provide for solidification and desired in-line travel. The polymeric coating layers on the single surface of the strip, in contact with the heat-removal internally-cooled surface of rotating 42 are solidified, such that the solidified polymeric coating and strip separate from roll 42, for in-line travel, as shown.

Single-surface polymeric coated strip 48 of FIG. 2 departs from roll 42, in the direction indicated, presenting one-surface with solidified polymeric coating having sufficient green-strength-adhesion for in-line travel. The solidified polymeric overhang is preferably promptly trimmed, at knife-edge trimming station 49.

Strip 48 continues travel toward surface activating equipment for the remaining surface. The number of open-flame units and corona discharge units for the remaining surface, correspond to those selected earlier, as described, based on line speed. Open flame burners 50 and 51 and/or corona discharge unit 52, are used to remove surface contaminants, if any, and activate the remaining surface for enhanced bonding with a first-contacting polyester layer, as described above.

Strip 53, with one-surface polymeric-coated and the remaining pre-treated for accepting such polymeric coating, travels toward nip 54. The pre-treated surface of strip 53 confronts an infra-red unit for heating that remaining surface, to the selected temperature, as described earlier. The strip with surface temperature established above about 200° F., travels directly into coating nip 54, as established between back-up pressure roll 55 and heat-removal roll 56; each rotating, as indicated, with designated surfaces performing as previously described.

Pre-selected thermoplastic polymers for each polymeric layer, are formulated to specifications, and supplied to extruding apparatus 57, from supply sources 58, 59. The polymers are heated and pressurized for extrusion as distinct polymeric layers, as previously described. The first-contacting PET layer and the selected finish-surface polyester layer, as described earlier, are extruded simultaneously, as distinct layers, under pressure from extrusion apparatus 57.

The remaining single-surface of strip 53 is pre-heated, as described earlier, for entry into nip 54 between rolls 55 and 56, for deposition of the extruded polymeric layers. Those polymers are heated to at least melt temperature and can be about 50° F. above melt temperature.

Heat is removed from the polymeric layers and the strip 53 by cooling and the metallic surface of heat-removal roll 56, from internally of roll, so as to solidify the polymeric coatings. Internal cooling of roll 56 provides a surface temperature in the range of about 50° F. to 75° F. As the polymers are solidified, strip 61 departs roll 56, as shown, for in-line travel.

Polymeric overhang is also solidified; and, is trimmed edge-trimming unit 62, as strip 61 travels in-line travel toward a finishing stage. Strip 61, with solidified polymeric layer on each respective surface, travels to finishing heater 66, at which, the polymeric coatings on both surfaces are heated to melt temperature, the strip can also be heated. The objective is to heat both coated surfaces uniformly throughout; an induction heating unit can be used to expedite heating of the polymeric layers on the strip.

Strip 70 with melted polymeric coating travels in-line for a selected brief interval, which is a matter of a few seconds, so as to complete the bonding of the first-contact layer, with each substrate surface, by filling valleys or crevices remaining, if any, due to the topography of each metallic surface. The external finish-surface polymeric layer bonds with the first-contacting layer on each respective surface; and, a smooth exterior finish results on each such polymeric-layer coated surface.

Then, the polymeric layers on both surfaces are rapidly cooled through glass-transition temperature of the melted polyesters in quench bath 74. The heat-removal solution of bath 74 can be selected and is handled taking into account the high temperature at introduction to the bath. Laminar flow of the solution along both surfaces of strip is provided by flow-unit 75 which pumps cooler liquid from tank 74, which is introduced at 76 for laminar flow along the surfaces of the strip. Heat-removal from the quench bath solution, in view of the high-temperature polyesters can be augmented; for example, by heat exchanger unit 77.

Rapid-cooling of the polymeric coating through glass-transition temperature, produces non-directional amorphous characteristics throughout the polymeric layers which facilitates future fabrication. Cooling liquid is removed from the strip at wringer-roll station 78; and the strip is dried at dryer 79. Strip 80 travels through looper 81 and bridle-roll station 83, for selective handling at recoil section 82; or, for a polymeric surface treatment for activation by corona-discharge treatment at unit 84, which prepares that surface for lithographic printing or other pre-fabrication steps at Station 85.

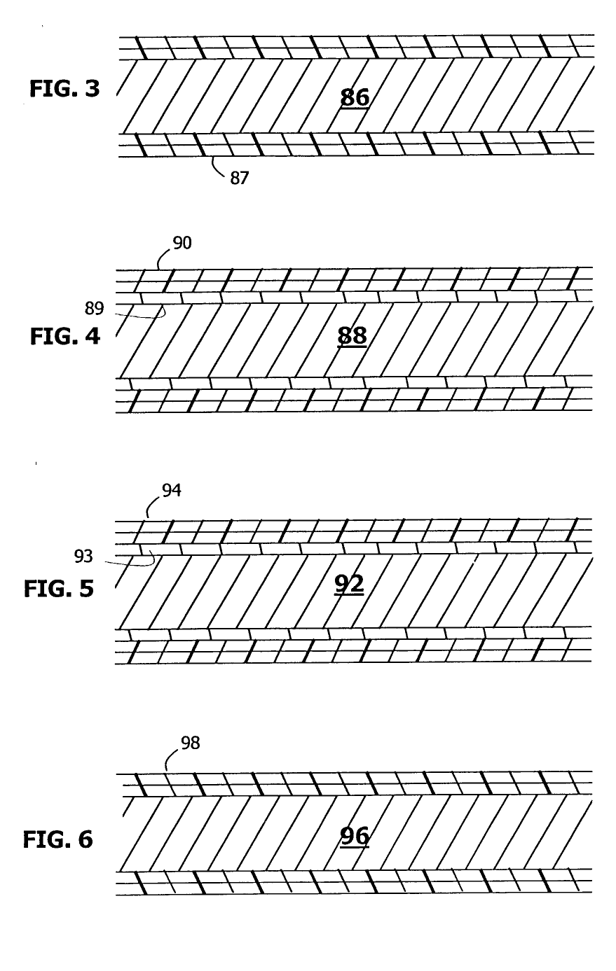

In FIG. 3, rigid aluminum sheet metal 86 is coated with the polymeric layers for use in fabricating rigid sheet metal containers for canning liquids. Continuous-strip pre-coating with polymeric layers as indicated as one surface at 87, provides an interior pin-hole free integrity; avoiding dissolution of the aluminum substrate, which is an important taste factor.

In FIG. 4, a rigid mild steel substrate 88, includes a non-ferrous metallic protective coating 89, on each respective surface. Such metallic coating, for example, is selected as described above from: electrolytic tinplate flat-rolled steel or electrolytic chrome/chrome oxide (TFS) plated flat-rolled steel which is prepared for containers. Full-finish blackplate comprises flat-rolled low-carbon steel with a cathodic dichromate treatment achieved by immersion in cathodic dichromate, or electrolytic action, depended on intended coating thickness.

Each respective protective metal surface is polymeric coated as shown at 90, and as described above. Typical uses would be container manufacture, in which one or more of the polymeric surfaces can include a colorant, such as T₁O₂; and, for certain construction uses.

In FIG. 5, mild steel substrate 92, is hot-dip zinc-spelter coated on each surface with a single such surface coating being designated reference number 93. Both such hot-dip zinc-spelter surfaces are polymeric coated with dual polyester layers, as indicated on a single surface reference number 94; in a manner described in relation to FIGS. 1 and 2. A preferred use for such product is air duct systems. The glass-like finish surfaces decreases air friction and diminish air handling costs. Also, an interior duct finish surface, for example, as located at a heat-exchange station, where such panels could be replaced, would include zeolite-encased silver, which acts as a antimicrobial agent to decrease air borne bacteria.

Other uses for the polymeric coated strip of FIG. 5 include: polymeric insulated metallic doors for residencies, apartments, etc.; door framing and window framing for both internal and external usage; and, other polymeric insulated construction elements, such as 2×4's.

In FIG. 6, an aluminum/magnesium alloy substrate at reference number 96 provides a rigid high-strength light-weight substrate, which coated directly with polymeric layers on each surface; one such surface coating is designated by reference number 98. Such dual polymeric coatings are extrusion-deposited, as described in relation to FIGS. 1 and 2; the resulting engineered composite provides for panel use in air conditioning units, and the like; for duct work, and for small-boat, automotive and tractor panel manufacture; each with desired substrate strength and durable polymeric production, which can be include colorant; or can be readily painted.

Mild steel, or low-carbon steel, as referred to herein, contains about 0.02 to bout 0.03% carbon, and is available with various selected single-reduced or double-reduced tensile strengths; and temper ratings, before polymeric coating.

The thickness of continuous-strip flat-rolled mild steel for electrolytic plating purposes is generally designated by base-weight from about fifty to one hundred and thirty five pounds per base box; in which base box is defined as an area of 3136 square inches. The tensile strength for single reduced (SR) temper 4, 5 mild steel is about forty to fifty thousand pounds per square inch; a double-reduced (DR) Temper 8, 9 would have a tensile strength of about eight to ninety thousand pounds per square inch.

Chrome/chrome oxide (TFX) non-ferrous metallic coating low-carbon would be TFX coated in the range of about 0.3 to 2.0 mils per surface; which includes about three to thirteen mg. per square foot chrome, and about 0.7 to about 2.4 mg. per square foot chrome oxide.

Electrolytically tin plating mild steel, of uniform coating weight on each surface, or differentially-coated on each surface; would have coating weight selected in the range of 0.05 to about 1.25 pounds per base box.

A hot-dip zinc-spelter coating for rigid flat-rolled mild steel would be selected in a weight range of about 0.4 to about 0.9 ounce per square foot, total both surfaces; that is: about 0.2 to about 0.45 ounce per square foot at coated surface, zinc spelter finishes can be selected from differing types of spangle, an iron/zinc alloyed surface, or as a brushed-bright reflective surface. Aluminum content of hot-dip zinc-spelter is selected; and, can vary from about 0.1% to about 50% for GALVALUM™; also, certain special hot-dip spelters, such as GALFAN®, further include misch-metal additives.

The polyester polymeric layers, described above, are coated in a range of about one mil to about two mils per surface, for most purposes; but a coating thickness of about four mils can be used for exterior construction purposes. Such polyester polymeric layers are ordered to specifications from:

Eastman Chemical Co.

100 N. Eastman Road

Kingsport, Tenn. 37660-5230

Open-flame burners, to size specifications for the line, are ordered from:

Flynn Banner Corporation

425 Fifth Ave.

(P.O. Box 431)

New Rochelle, N.Y. 10802

Corona discharge electrodes are ordered to specification from:

Enercon Industries Corp.

W140 N9572 Fountain Boulevard

Menomonee Falls, Wis. 53052

The polymeric extrusion apparatus, for two polymeric layers are described above; ordered to specifications considering line-speed can be ordered from:

Black Clawson Converting Machinery, LLC.

46 North First Street

Fulton, N.Y. 13069.

While specific values, dimensional relationships, and other specifics have been presented for purposes of describing contributions of the invention, it should be recognized that with the benefit of the above disclosures, variations in those values could be resorted to by those skilled in-the-art, while relying on the novel concepts and principles of the above disclosure. Therefore, for purposes of evaluating patent coverage for the disclosed invention, reference should be made to the scope of the appended claims, for interpretation in the light of the above disclosures.

What is claimed is:

1. Process for continuous-in-line extrusion coating of elongated flat-rolled sheet metal with thermoplastic polymers, comprising the steps of:
A) directing elongated rigid flat-roll sheet metal continuous-strip, moving in-line in the direction of its length, presenting substantially-planar opposed surfaces extending width-wise between longitudinally-extending lateral edges of such strip;
B) pre-treating a single-surface of such strip, while moving in-line, to enhance green-strength-adhesion for polymeric extrusion coating sufficiently to enable continuous-in-line travel of such strip with such extruded polymeric coating adhering to such single pre-treated surface; in which:
surface pre-treating steps are selected from the group consisting of:
(i) impinging an open-flame while adjusting air/fuel mixture of such flame, to achieve an oxidizing reaction, on such single surface, resulting from such flame impingement,
(ii) establishing an electrical potential, with such single-surface of such strip, for ionizing gas above such surface by providing a corona-discharge, free of electrical arcing, with such single-surface, and
(iii) combinations of (i) and (ii) in any sequence; and, further
preparing such single surface for polymeric coating by establishing a surface-temperature,
enabling deposition of a pre-selected first-contacting extruded polyester layer substantially free of disruption in such pre-selected polyester first-contacting layer as deposited;
C) pre-selecting thermoplastic polyesters for combining to form multiple polymeric layers, consisting essentially of;
(i) polyethylene terephthalate (PET) layer for first-contacting and bonding with metallic-surface, and
(ii) a finish-surface layer, for bonding with such first-contacting layer, selected from the group consisting of:
(a) polyethylene terephthalate (PET),
(b) polybutylene terephthalate (PBT), and
(c) a combination of (a) and (b);
D) preparing such polymeric layers for extruded association with such single surface by:
(i) melting and pressurizing such polymers, as selected for each such polymeric layer.
(ii) extruding each such melted polymeric layer under pressure, so as to enable:
(iii) depositing each as a distinct polymeric layer;
E) presenting such single surface, as pre-treated and prepared with such established surface temperature, so as to enable deposition of such first-contacting PET layer, free of substantive disruption in such first-contacting PET layer, while such continuous-strip is moving in the direction of its length;
F) extruding each such melted polymeric layer under pressure for deposition;
G) depositing each such melted polymeric layer as a distinct layer so as to extend across strip width, and extending so as to establish an overhang of such polymeric layers at each such lateral edge of such strip, with such deposition being carried out by:
(i) establishing first-contact of such polyethylene terephthalate (PET) bonding layer with such pre-treated single metallic surface having an established surface temperature for avoiding disruption in such (PET) layer, as deposited, while:
(ii) depositing such selected finish-surface polymeric layer so as to bond with such first-contacting deposited layer; then
H) solidifying such multiple polymeric layers, and solidifying such polymeric overhang along each lateral edge of such strip, by removing heat from such polymeric layers and strip, while continuing travel of such strip in the direction of its length; then
I) trimming such solidified polymeric overhang along each lateral edge, while such strip is traveling in the direction of its length; then
J) preparing such single remaining non-polymeric coated surface of such strip, while the strip is traveling in the direction of its length, as set forth in Paragraph B, by:
i) selecting surface pre-treatment steps as set forth above, for enhancing green-strength-adhesion sufficiently for continued in-line travel; and
ii) establishing a surface temperature for such single remaining surface for facilitating extruded deposition of such pre-selected first-contact molten PET polymeric coating, substantially free of disruption during deposition on such surface;
K) pre-selecting thermoplastic polymers for combining into multiple polymeric layers as set forth in Paragraph C above;
L) preparing such polymeric layers by melting and pressurizing so as to enable deposition as distinct layers, as set forth in Paragraph D above;
M) moving such continuous-strip in the direction of its length and presenting such remaining-single surface, as pre-treated surface-temperature prepared for polymeric coating;
N) extruding such multiple polymeric layers under pressure, for depositing in association with such single remaining opposed surface, as distinct layers, across strip width and extending further so as to produce a polymeric overhang along each lateral edge of such strip, as set forth in Paragraph G above;
O) solidifying such single-remaining surface polymeric layers, and solidifying such polymeric overhang along each such lateral edge, while such strip is traveling in the direction of its length as set forth in Paragraph H above;
P) trimming such solidified polymeric overhang along each lateral edge; then
Q) finishing treatment of such polymeric layers on both such opposed surfaces, by
(i) selecting a temperature for melting such polymeric layers on each surface, and for heating such strip,
(ii) continuing in-line travel of such strip with heated polymeric layers in the direction of its length for a predetermined interval, resulting in:
(iii) completing bonding of each such first-contacting polymeric layer with each such respective opposed metallic surface of such strip, while also bonding each such exterior finish-surface polymer layer with each such respective first-contacting polymeric layer; prior to
R) rapidly-cooling such polymeric layers on both opposed surfaces of such strip, through glass-transition-temperature for such layers, resulting in:
(i) establishing amorphous non-directional characteristics in such polymeric coating on each opposed surface, while also
(ii) cooling such strip; and
S) directing such polymeric-coated strip for selection from the group consisting of:
(i) coiling, and
(ii) initiating steps for end-product utilization of such polymeric-coated strip.

2. The process of claim 1, in which
such surface temperature is established above almost 200° F., for preparing each such respective single surface for polymeric deposition so as to be substantially free of disruption in such first-contacting polyester layer as deposited on each such respective surface.

3. The process of claim 1, including
establishing each such respective surface temperature, for such first-contacting polyester polymeric layer, by selecting a temperature in the range of about 230° F. to about 245° F.

4. The process of claim 1, including
selecting a combination of open-flame pre-treatment and corona discharge pre-treatment for each such single-opposed surface as treated, in which
such a flame-treatment and corona discharge treatment are carried out in a sequence during in-line travel, so as to augment establishing such surface-temperature, for each repetitive single surface for depositing each respective first contacting PET layer, substantially free of surface disruption during such deposition.

5. The process of claim 2, in which
solidifying polymeric layers on each such single-opposed surface, while such strip is traveling in-line by establishing in-line heat removal contact with each finish-surface polymeric layer, for each such respective opposed surface and, maintaining such heat removal contact at a temperature in the range of about 50° F. to about 75° F.

6. The process of claim 1, including:
supplying flat-rolled rigid sheet metal strip by selecting from the group consisting of
(i) low-carbon steel,
(ii) aluminum, and
(iii) aluminum/magnesium alloy.

7. The process of claim 6, including
supplying rigid flat-rolled low-carbon steel strip having a substantially-uniform thickness gage in the range of about 0.005″ to about 0.015″, and, further:
providing a non-ferrous metallic corrosion-protective coating for opposed surfaces of such steel strip, selected from the group consisting of:
electrolytic plated tin,
electrolytic plated chrome/chrome oxide,
cathodic dichromate treatment,
electrolytic plated zinc, and
hot-dip zinc spelter.

8. The process of claim 7, including
selecting a hot-dip zinc-spelter coating weight, total for both surfaces, in the range of
about 0.4 ounces/sq. ft., to
about 0.9 ounces/sq. ft.

9. The process of claim 8, further, comprising:
including in such finish-surface selected polyester layer, on at least one such opposed surface, an antimicrobial agent for decreasing accumulation of airborne bacterial spores in an air duct system.

10. An engineered-composite, comprising a coacting combination of
rigid flat-rolled sheet metal continuous-strip presenting opposed substantially planar surfaces, each surface including:
solidified polymeric-coating produced in accordance with the process of claim 1.

11. An engineered-composite, consisting essentially of
rigid flat-rolled sheet metal continuous-strip, with opposed substantially-planar surfaces, presenting
solidified uniformly-extruded polyester polymeric coating layers produced in accordance with the process of claim 2.

12. An engineered-composite, consisting essentially of
continuous-strip rigid flat-rolled mild steel having a protective non-ferrous metallic-coating on each opposed substantially planar surface, and
solidified polymeric coating layers, on each such non-ferrous metallic-coated strip surface of such steel strip, produced in accordance with the process of claim 7.

13. An engineered-composite, consisting essentially of
hot-dip zinc spelter coated rigid flat-rolled mild steel continuous-strip, presenting
a solidified finish-surface polymeric-layer on at least one such zinc-spelter-coated surface, which includes
an antimicrobial agent produced in accordance with process of claim 9.

14. Continuous-in-line apparatus for polymeric extrusion-coating of continuous-strip rigid flat-rolled sheet metal, comprising
A) means for supplying elongated flat-rolled rigid sheet-metal continuous-strip for travel in-line in the direction of its length, with substantially-planar opposed surfaces extending width-wise between longitudinally-extending lateral edges of such strip;
B) in-line pre-treatment and preparation means for a single planar surface of such traveling continuous-strip for preparing such surface for accepting polymeric extrusion coating and providing sufficient green-strength-adhesion for in-line travel, including
(i) surface pre-treatment means selected from the group consisting of:
an open-flame treatment means with regulated air/fuel mixture for impingement on such single surface so as to provide an oxidizing reaction on such surface for augmenting acceptance of such polymeric coating,
corona discharge means for such single surface for augmenting green-surface adhesion of such polymeric coating on such single surface, and
any combination of (a) and (b); in any sequence; and further including
(ii) in-line heating means for establishing a selected surface temperature for such surface which facilitates distortion-free deposition of a selected first-contacting thermoplastic polyester layer;
C) polymeric supply means for forming selected thermoplastic polymers for at least two distinct polymeric layers, in which
thermoplastic polymers for such polymeric layers consisting of:
(i) a polyethylene terephthalate (PET) bonding layer, for first contacting of such metal surface, and
(ii) a finish-surface polyester layer selected from the group consisting of:
(a) polyethylene terephthalate (PET),
(b) polybutylene terephthalate (PBT), and
(c) a combination of (a) and (b);
D) polymer extrusion means for melting and pressurizing polymers forming such distinct polymeric layers, so as to enable extrusion deposition while such strip is traveling in the direction of its length, with
such extrusion means including:
(i) polymer die means for extruding each polymeric layer, so as:
(a) to extend, as distinct layers, associated with such single surface across strip width, and
(b) to establish an overhang of such polymeric layers at each lateral edge of such strip, with
(ii) such bonding polyethylene terephthalate (PET) polymeric layer first contacting such pre-treated established surface temperature single surface, and, with
(iii) such remaining selected polyester polymeric layer being deposited onto such first-contacting layer;
E) in-line heat removal means for solidifying such multiple polymeric layers on such single surface of such strip, along with solidifying such polymeric overhang along each such lateral edge, while such strip is traveling in the direction of its length;
F) in-line edge trimmer means for removing such solidified polymeric overhang, along each lateral edge, while such strip is traveling in the direction of its length:
G) in-line means for pre-treating such remaining opposed planar surface for enhancing reception a polyester polymeric coating, with
(i) such remaining surface pre-treating means being selected from the group as set forth in Paragraph B above, while
(ii) pre-treating such surface which such strip is traveling in the direction of its length, including
(iii) heating means for establishing a surface temperature, for receiving such first-contacting PET layer substantially free of disruptions in such layer;
H) polymeric supply means for thermoplastic polymeric layers as set forth in Paragraph C above;
I) extrusion means, as set forth in Paragraph D above, for extruding such selected melted and pressurized polymeric layers as distinct polymeric layers to extend across such strip width and to establish polymeric-layer overhang along each lateral edge of such strip:
J) in-line heat removal means for solidifying such deposited polymeric layers on such single remaining opposed surface, as well as solidifying such polymeric overhang along each lateral edge, as such strip is traveling in the direction of its length;
K) trimmer means for removal of such solidified lateral edge overhang during travel of such strip in the direction of its length;
L) finishing means, including
(i) heating means located for melting polymeric layers on both such opposed surfaces while such strip traveling in the direction of its length,
(ii) means providing for in-line travel during a pre-selected time interval for facilitating completing of bonding of such first-contacting polymeric layer with each such opposed planar surface, and
between such first-contacting layer and its respective external finish-surface polymeric layer; and
(iii) means for rapidly cooling such polymeric layers, through glass-transition-temperature while such strip is moving in the direction of its length, for establishing non-directional amorphous characteristics in such polymeric layers; and
M) means for directing such strip with solidified polymeric-coating on each surface for selection from the group consisting of:
(i) coiling, and
(ii) initiating steps for end-product utilization.

15. The apparatus of claim 14, in which:
such heat-removal means for solidifying extruded polymeric layers associated respectively with each such single opposed surface, comprises:
(i) in-line movable surface means for contacting each such respective finish surface polymeric layer for in-line heat removal, with
(ii) cooling means for maintaining such heat-removal surface within a predetermined temperature range of about 50° F. to about 75° F. during in-line contact with each such respective polymeric layer.

16. The apparatus of claim 14, in which such means for rapidly cooling polymeric layers associated with both such opposed surfaces, comprises;
quench bath means containing a heat transfer liquid of selected boiling temperature,
recirculating means for providing laminar-flow movement of such heat-transfer liquid along such polymeric coated surfaces for facilitating heat removal from polymeric layers on each such opposed surface.

17. The continuous-in-line apparatus of claim 14, including
supply means for delivering continuous-strip flat-rolled rigid sheet metal, selected from the group consisting of
(i) a low carbon steel,
(ii) aluminum, and
(iii) aluminum/magnesium alloy.

18. The continuous-in-line apparatus of claim 14, in which
such polyester finish-surface layer of Paragraph C includes an antimicrobial agent.

19. The continuous-in-line apparatus of claim 17, in which:
(i) such strip supply means is selected for supplying flat-rolled low-carbon steel substrate having a thickness gage in the range of about 0.005″ to about 0.015″, having
(ii) a protective non-ferrous metallic coating for opposed surfaces of such steel substrate, selected from the group consisting of:
electrolytic plated tin,
electrolytic plated chrome/chrome oxide,
cathodic dichromate treatment,
electrolytic zinc plating, and
hot-dip zinc spelter.

20. The continuous-in-line apparatus of claim 18, in which
(i) means are selected for supplying a hot-dip zinc spelter coated flat-rolled steel strip substrate, and, in which
(ii) such finish-surface selected polyester layer, on at least one such opposed surface, includes:
an antimicrobial agent for decreasing airborne bacterial spores.
